(19) United States
(12) Patent Application Publication
(10) Pub. No.: US 2020/0234305 A1
(43) Pub. Date: Jul. 23, 2020

(54) IMPROVED DETECTION OF FRAUDULENT TRANSACTIONS

(71) Applicant: KBC GROEP NV, Brussels (BE)

(72) Inventors: Albert KNUTSSON, Mechelen (BE); Barak CHIZI, Woluwe (BE)

(21) Appl. No.: 16/623,292

(22) PCT Filed: Jun. 18, 2018
(86) PCT No.: PCT/EP2018/066101

§ 371 Date: Dec. 16, 2019

Related U.S. Application Data
(60) Provisional application No. 62/520,806, filed on Jun. 16, 2017.

(30) Foreign Application Priority Data
Jun. 16, 2017 (EP) 17176399.8

(51) Int. Cl. G06Q 20/40; G06N 20/00; G06F 17/15

(52) U.S. Cl. CPC G06Q 20/4016; G06F 17/153; G06N 20/00

(57) ABSTRACT

The current invention relates to a method of identifying relevant records in a database, preferably of determining potentially fraudulent records in said database. A graphical user interface is provided to a user to display multiple inputs, to receive inputs from the user and to display results. A first detection strategy targeted to detect existing records from the database is defined. The first detection strategy comprises multiple first inputs that comprise at least one threshold, at least one detection method, at least one weighting factor, and at least one parameter. The first inputs can be individually displayed on said graphical user interface for each of the at least one detection method. The first inputs can preferably be individually set for each of the at least one detection method. A second detection strategy targeted to detect said existing records from the database is defined. The second detection strategy comprises multiple second inputs.

### TECHNICAL FIELD

The invention pertains to the technical field of systems for detecting fraud in financial transactions.

### BACKGROUND

Existing fraudulent transaction detection systems may use transaction data in addition to data related to the transacting entities to identify fraud. Such systems may operate in either batch (processing transactions as a group of files at periodic times during the day) or real time mode (processing transactions one at a time, as they enter the system). Typically, the system identifies transactions with high risk of being fraudulent, which are manually investigated by a user, typically a domain expert, on a daily basis. However, the fraud detection capabilities of existing systems have not kept pace with either the types of fraudulent activity that have evolved or increasing processing and storage capabilities of computing systems.

There remains a need in the art for an improved system for identification of fraudulent transactions. The user working with current systems and methods is confronted with the excessively time consuming process of manually investigating too many false positives, while missing some of the fraudulent transactions because the system is unable to detect them.

EP 2 866 168 discloses a method of determining potentially fraudulent records in a database comprises defining a detection strategy. EP 2 866 168 provides means for the user to calibrate the detection, yet these means are limited and lack flexibility, hence not allowing the user to calibrate the detection in an effective way.

U.S. Pat. No. 7,668,769 discloses a system and method of detecting fraud in transaction data such as payment card transaction data. One embodiment includes a computerized method of detecting that comprises receiving data associated with a financial transaction and at least one transacting entity, wherein the data associated with the transacting entity comprises at least a portion of each of a plurality of historical transactions of the transacting entity, applying the data to at least one first model, generating a score based on the first model, and generating data indicative of fraud based at least partly on the score. Other embodiments include systems and methods of generating models for use in fraud detection systems.

US 2015/0046302 discloses a method that involves receiving transaction data regarding a financial transaction, such that the transaction data includes a transaction attribute. A customer level target specific variable layer is generated from the transaction data through a processor. The cardholder behavior is modeled with the customer level target specific variable layer to create a model of cardholder behavior through the processor. The model of cardholder behavior is saved to a non-transitory computer-readable storage medium.

U.S. Pat. No. 6,330,546 discloses an automated system and method that detects fraudulent transactions using a predictive model such as a neural network to evaluate individual customer accounts and identify potentially fraudulent transactions based on learned relationships among known variables. The system may also output reason codes indicating relative contributions of various variables to a particular result. The system periodically monitors its performance and redevelops the model when performance drops below a predetermined level.

A problem with systems and methods according to U.S. Pat. No. 7,668,769, US 2015/0046302 and U.S. Pat. No. 6,330,546 is that they are too complex and lack transparency in their operation. Moreover, they lack means for benchmarking results obtained from the system according to a first model to those of another system or to those of the same system obtained according to a second model. They also lack means for the user to calibrate the detection in an effective way.

US 2016/0125424 discloses a method that involves implementing at least one rule for dynamically identifying accounts as being illegitimate based on some of a feature metrics and threshold values. An unidentified account absent is received from a set of accounts. The one or more assessment metrics is calculated based at least in part on the feature metrics determined for each account in the set. The unidentified account as being illegitimate is identified based on the at least one rule when the one or more assessment metrics satisfy the at least some of the threshold values.

A problem with the method according to US 2016/0125424 is that it is not directed at the identification of fraudulent financial transactions but rather to the identification of illegitimate accounts in an online (social network) context. It also lacks means for the user to calibrate the detection in an effective way. As such, US 2016/0125424 does not disclose means to identify fraudulent transactions an sich. Related, many of the key features and feature metrics relevant to identification of fraudulent transactions go unmentioned in US 2016/0125424.

The present invention aims to resolve at least some of the problems mentioned above.

### SUMMARY OF THE INVENTION

In a first aspect, the present invention provides a computer-implemented method according to claim 1.

In a preferred embodiment, the at least one detection method concerns at least two detection methods.

A main advantage over prior art methods and systems according to, e.g., EP 2 866 168, is that the calibration does not relate to a single detection strategy, but to at least two distinct detection strategies. This difference may be appreciated from the example embodiments worked out in Example 2 and 3, respectively. A first advantage of the invention is that it allows a user familiar with a traditional first detection strategy to calibrate a second detection strategy based on a machine learning algorithm, with potentially superior performance. Hereby, the term “machine learning algorithm”, in its broadest interpretation, refers to any data processing algorithm capable of processing the output of the at least one detection method in a fashion that enables taking into account correlation between the output of at least a first and a second detection method belonging to said at least one detection method, preferably at least two detection methods. In other words, the output of the machine learning algorithm, preferably the score produced by the machine learning algorithm, is not based entirely on a linear sum of outputs, linearly weighted or non-weighted, of the outputs of the at least one detection method, preferably at least two detection methods. As the applicant found that some machine learning algorithms are particularly suitable for the task of identifying relevant records in a database, in a preferred embodiment, the second strategy relates to at least one machine learning algorithm comprising a gradient boosting machine model and/or a random forest model and/or a support vector machine model.

The second detection strategy is advantageously based on at least one machine learning algorithm, having as input another set of detection methods, which is advantageously chosen equal to the detection methods of the first detection method. This measure has the benefit of decreasing both the necessary mental and physical effort of the user with respect to the machine learning algorithm. Particularly, given the inherent potential of the machine learning methods, combined with the potentially large number of detection methods (e.g. 42 in Example 3, in other embodiments 70 or more than 70), the number of possible values a corresponding variable vector, preferably a Boolean variable vector, can take on amounts to 2⁴², which is larger than 10¹², clearly demonstrating the distinctive character of the input which may be provided to the machine learning algorithm(s). Moreover, as the machine learning algorithms may associate large or small scores with any combination of Boolean variable values, without being bound by the constraint of linear combinations according to a strategy based on the sum of linearly weighted detection methods, as is the case in EP 2 866 168, the machine learning algorithms have a much finer sense of distinguishing between relevant and non-relevant transactions.

This larger sense of distinguishing may be understood as follows. For instance, the change of a single, e.g. Boolean, variable value in view of its combination with two or three correlated other variable values may indicate a big difference in practice and may be adequately reflected in the machine learning model behavior, but can never be modeled by a linear sum of linearly weighted detected methods according to EP 2 866 168, since such a sum cannot model the correlation between different variable values. Hence, by choosing detection methods for the machine learning algorithm(s) equal to the detection methods of the first detection method, and by using the Boolean variable vector as single input to the machine learning algorithm(s) and not using the weighting factors, the complexity of both the problem and the user interface is greatly simplified for the user, without losing the advantage of the machine learning algorithms, being able to capture correlation between different outputs of the detection methods. This said, machine learning algorithms still confront the user with great complexity, and therefore, the configuration and, if applicable, the training of these algorithms is preferably left over to an expert which is typically different from the user. Therefore, the invention advantageously confronts the user with the machine learning algorithms in their “operational state”. Rather than looking for the most suitable or best-configured machine learning algorithm, the user may direct its attention to the more practical question of which machine learning algorithm, optionally configured with some algorithm parameter, happens to perform best for the task at hand. Whether the algorithm owes its superior performance more to good configuration or is simply better suited for the job, is a question that need not necessarily be addressed by the user, and may or may not be irrelevant for the tasks performed by the user.

A second advantage is that it allows the user to calibrate two strategies at the same time, having the advantage of “a second opinion” during the detection of fraudulent transactions which is a true alternative to the first “opinion”, and not just some variant based on the modification of a single parameter.

A third advantage is that the user may aim for calibrating the first detection algorithm which may be a “traditional” detection algorithm based on sum of weights, which is more easy to understand and manage, by letting a machine learning algorithm provide hints toward improvements of the “traditional” first detection algorithm.

In a second, third and fourth aspect, the invention provides a system according to claim 16, a use according to claim 17, and a computer program product according to claim 18.

Further embodiments and their advantages are discussed in the detailed description and the conclusions.

### DESCRIPTION OF FIGURES

FIG. 1 illustrates an example workflow relating to the present invention.

FIGS. 2A-2B illustrate an example prior art user interface.

FIGS. 3A-3B illustrate an example user interface relating to the present invention.

### DETAILED DESCRIPTION OF THE INVENTION

In this document, the terms “signal” is used interchangeably with either of “detection method” and “detection method output”. Also the terms “signal vector” and “variable vector” are used interchangeably, so as the terms “Boolean signal vector” and “Boolean variable vector”. The term “scoring model” may refer to any of the algorithms used in the first or second detection strategy. The terms “model” and “algorithm” are used interchangeably unless indicated otherwise.

In this document, “financial transactions” and “transactions” are used interchangeably. Transaction data refers to transactions, authorization of transactions, external data and other activities such as non-monetary transactions, payments, postings or cardless cash withdrawal events. Hereby, a transaction may concern any payment or related action with the final intent of generating a transaction from a sender to a recipient, and thus comprises all payment card transactions, as well as transactions originating from actions performed via a web page on a computer and/or via a mobile app on a mobile device. Moreover, payment card transaction data may include data derived from transactions using a physical payment card, e.g., with a magnetic stripe, and electronic transactions in which payment card data is used without the payment card being physically read or presented, such as cardless cash or an online payment by credit card without requiring chip identification or any other type of physical verification of the presence of the card. Financial transactions can include credit or debit based transactions associated with, for example, a point of sale (POS) terminal or an automated teller machine (ATM). These transactions are often aggregated into databases from which an analysis can be performed for fraud.

Furthermore, in this document, fraudulent transactions originate from the action of a party responsible for said fraud, generically referred to as “fraudster”. One type of fraudster is the “cyber-criminal” performing an important part of its fraudulent activities online. This is to be distinguished from the generic terms “sender”, “beneficiary”, “card user” and “account user”, which all refer to parties associated with a transaction, comprising both legitimate parties and fraudsters.

The scoring models mentioned in this document may be based on any suitable modeling technique. Accordingly, in yet another embodiment of the system, the at least one scoring model may comprise gradient boosting machine, random forest, support vector machines (SVM), neural networks, cascades (which may significantly improve performance for real-time referrals if trained on fraud transaction tags (identifying training transactions as fraudulent) rather than fraud account tags (identifying accounts as being used fraudulently)), genetic algorithms (GA), fuzzy logic, fraud case-based reasoning, decision trees, naive Bayesian, logistic regression, and scorecards.

The at least one scoring model may be supervised (i.e., with fraud tagging of the training data) or unsupervised (i.e., without fraud tags). In one embodiment of the system according to a supervised approach, the system allows the user to add user-assigned labels while using the system, which are subsequently added to the training data. This allows training of the scoring model and the system at runtime. In a related embodiment with a supervised approach which may optionally be combined with said approach with user-assigned labels, the training data is provided beforehand and the model is trained and configured at least partly before it is used. The unsupervised scoring models can help identify new fraud trends by identifying accounts and transactions that are diverging from legitimate behavior, but that do not diverge in a way previously identified. The unsupervised models may be for instance be based on one or more of clustering (e.g., K-means or Mahalanobis distance based models), anomaly (or outlier) detection (e.g., isolation forest or compression neural networks), competitive learning (e.g., Kohonen self-organizing maps) and one-class support vector machine (SVM).

While a large number of scoring models may run concurrently on the system, it is a desired outcome that a limited number of models, e.g. one, two or three, are identified as providing superior performance, either taken alone or in their combination, and therefore “elected” as best options. Preferably, these scoring models have fewer inputs than typical monolithic models, and they can be refreshed or retrained much more efficiently. If it is desirable to retrain a particular scoring model, such retraining can be performed without retraining the other scoring models. In a preferred embodiment, the system comprises a first and a second scoring model. Hereby, the first scoring model preferably represents an approach that is familiar to and well-understood by the user of the system, with known strengths and weaknesses, whereas the second scoring model preferably concerns a newer scoring model of which the performance can be assessed by comparing its results to those of the first scoring model. The present invention is particularly suitable for this type of experimental comparison, given that each of said at least one scoring model applied in step (e) is applied to the same signal vector obtained in step (d). The fact that a common signal vector is used is helpful to the user since it provides a solid basis for a fair comparison between different scoring models. This a fortiori holds true for the part of the signal vector that concerns Boolean signal values, making the input of the at least one scoring model more predictable, and making it feasible for a user to gain familiarity with the typical behavior of each scoring model.

The present invention concerns a computing system according to claim 1.

In a preferred embodiment, said algorithm selection relates to at least two machine learning algorithms.

In a preferred embodiment, said second detection strategy comprises determining a second score being an output of one of said at least one machine learning algorithm chosen according to the algorithm preference received from the user, wherein said second score is based directly on the multiple second inputs consisting of the algorithm preference, an output of the at least one detection method of the first detection strategy and the at least one parameter of the first detection strategy, and not on a weighting factor. This may decrease both the necessary mental and physical effort of the user during said dynamic calibrating.

In a preferred embodiment, said multiple second inputs of the second detection strategy further comprise an algorithm parameter, and in that said dynamic calibrating further relates to altering said algorithm parameter.

In another preferred embodiment, said first detection strategy comprises determining a first score being a linear sum of at least one term, each term being associated with one of said at least one detection method, each term being a product of an output of the detection method and a weighting factor of the detection method wherewith the term is associated.

According to yet another embodiment, said jointly displaying of said results produced by the first detection algorithm and said results produced by the second detection algorithm comprises displaying a first score determined by said first detection strategy and a second score determined by said second detection strategy.

In one embodiment, for each of said at least one detection method, said output of the at least one detection method is a Boolean variable vector with one Boolean variable per detection method, wherein said second score determined by means of said at least one machine learning algorithm selected according to said algorithm preference is based solely on said Boolean variable without taking into account a weighing factor.

In another preferred embodiment, said records in said database relate to transaction entities and comprise at least any or any combination of the following: a device used to execute a transaction, a sender, a beneficiary, a transaction date, a transaction channel, a location of said sender, wherein preferably said records in said database comprise at least a sender, wherein preferably said at least one detection method relates to any or any combination of the following information relating to said sender: age, gender, income level, civil status, transaction pattern over time, geographic transaction pattern, first use of IP address, first use beneficiary account, first use of said device used to execute said current transaction or of app running on said device, first use of fingerprint within a payment app, previous transfer between own accounts, first transaction after enrolment, cardless cash after enrolment, cardless cash after limit increase, first use of cardless cash, transaction after request login ID, first use of easy PIN reset, first use language of client, limited use of internet service provider.

In yet another embodiment, said records comprise at least a transaction date, wherein said at least one detection method relates to any or any combination of the following: a time of the day and weekday, a seasonal feature for distinguishing e.g. Christmas or summer holidays, a current weather, simultaneousness of a fraud-relevant event such as a version release date of Kali Linux, an external indicator of cyber-criminality relating to said transaction date.

In a preferred embodiment, said records comprise at least a location of said sender, wherein said location of said sender is preferably obtained and/or verified via GNSS data and/or telecom data and wherein the application of said plurality of signal definitions in step (d) is done for a plurality of features relating to said location of said sender comprising at least any or any combination of the following: a local area crime rate, a local area unemployment rate, an external indicator of cyber-criminality relating to said location.

In a preferred embodiment, said at least one machine learning algorithm comprises a gradient boosting machine model and/or a random forest model and/or a support vector machine model.

In a preferred embodiment, said jointly displaying of said results produced by the first detection strategy and said results produced by the second detection strategy comprises marking at least one record for which results of the first detection algorithm and the second algorithm differ.

In another preferred embodiment, said marking of said at least one record comprises:
calculating a correlation between records for which results of the first detection algorithm and the second algorithm differ, preferably by calculating a correlation between the Boolean variable vectors associated with said records; and
displaying a result relating to said correlation, said result preferably comprising at least one detection method identified as characteristic of said difference between said first and said second detection algorithm.

In a preferred embodiment, the method comprises the further step of:
for at least one record, receiving a user-assigned label indicating whether the user deems said at least one record relevant, preferably fraudulent.

In a preferred embodiment, at least one of said at least one machine learning model concerns a supervised learning model relating to training data, wherein said receiving of said user-assigned label further comprises adding said user-assigned label to said training data.

In a preferred embodiment, said method comprises the further step of:
based on a difference between said results of said first detection strategy and said results of said second detection strategy, alerting the user for advising manual inspection, said alerting comprising any or any of the following: a sound alarm, a visual alarm on said graphical user interface, haptic feedback, a push notification to a mobile device of said user.

In a preferred embodiment, the signal vector obtained in step (d) consists of a plurality of Boolean signal values. Hereby, all signals take on only two different states as signal values, preferably “0” or “1”. This is advantageous since it facilitates the user and makes the use of an advanced model manageable. For instance, it allows to first apply a known and/or simple scoring model suitable to be applied to such a signal vector, and use this as a benchmark for the present system. Also, it allows to apply and compare two different scoring models belonging to the system in a transparent and generic way.

In another preferred embodiment, said at least one scoring model comprises at least a first scoring model and a second scoring model different from said first scoring model; and said first and said second model applied in step (e) are applied independently to the same signal vector obtained in step (d). This has the advantage that a user may apply two different scoring models of which for instance one is known and another one is under test. By applying these independently, maximal transparency is obtained, with generic application of several scoring models whose exact number may be chosen freely. In a related alternative embodiment, the at least one scoring model concerns a plurality of scoring models which are applied concurrently in step (e) and generate said fraud-indicative data in a mutually dependent manner. One example of such a setting is where a third scoring model uses the scores generated by a first and second scoring model and chooses a mode of calculation conditioned by these scores. Hereby, the third scoring model may use a simple weighting to combine the scores of the first and second scoring model, but may also follow a less trivial path. In one embodiment, a first and second scoring model provide scores which are combined by a third scoring model according to a weighting determined by a fourth scoring model. Such an embodiment may be preferably applied to reduce the burden on the user, who is preferably confronted with only a very limited number of scoring models and associated scores, e.g. 1 or 2.

According to another preferred embodiment, said one or more current transaction entities identified in step (b) comprise at least any or any combination of the following: a device used to execute said current transaction, a sender, a beneficiary, a transaction date, a transaction channel, a location of said sender. This is advantageous since each of said transaction entities is highly determining when assessing whether a transaction is fraudulent, especially in their combination. Moreover, each of said possible transaction entities is in itself quite general and may be related to a lot of historical data. In this regard, the mentioned transaction entities are particularly suitable for use in the system according to the present invention, in which historical data is advantageously utilized. Note that not all mentioned transaction entities are necessarily distinct and/or present for each transaction. For instance, in the case of a card user withdrawing cash, the card user is both sender and beneficiary at the same time. Also in the example of an account user withdrawing cash at a counter with the help of a clerk or by means of a signed bank transfer form, the account user is both sender and beneficiary. Also, note that in some cases some data relating to a transaction may be missing, which however should not impede the determination of whether said transaction is fraudulent.

In another preferred embodiment of the invention, said one or more current transaction entities identified in step (b) comprises at least a sender, and the application of said plurality of signal definitions in step (d) is done for a plurality of features relating to said sender, said plurality of features comprising at least any or any combination of the following: age, gender, income level, civil status, transaction pattern over time, geographic transaction pattern, first use of IP address, first use beneficiary account, first use of said device used to execute said current transaction or of app running on said device, first use of fingerprint within a payment app, previous transfer between own accounts, first transaction after enrolment, cardless cash after enrolment, cardless cash after limit increase, first use of cardless cash, transaction after request login ID, first use of easy PIN reset, first use language of client, limited use of internet service provider. Hereby, cardless cash refers to a bank service whereby a card user withdraws cash without requiring the physical presence of the associated card. Furthermore, said request for said login ID may refer to an account name in the context of a web application or an app on a mobile device or any other identification of a sender and/or a device of a sender used for the current transaction. Furthermore, an easy PIN reset may refer to a way of restoring access to or signing within the context of an application/app. Such restoral may be intended for a sender forgetting such a PIN, e.g. a four-, five- or six-digit PIN, wherein said easy reset may be enabled by identification via a mobile phone number. Since an assumed fraudster may have taken hold of the mobile phone of a sender, it may be easy to perform such an easy PIN reset, and therefore, a corresponding feature/signal should be identified.

In yet another embodiment, said one or more current transaction entities identified in step (b) comprises at least a transaction date, wherein the application of said plurality of signal definitions in step (d) is done for a plurality of features relating to said transaction date comprising at least any or any combination of the following: a time of the day and weekday, a seasonal feature for distinguishing e.g. Christmas or summer holidays, a current weather, simultaneousness of a fraud-relevant event such as a version release date of Kali Linux, an external indicator of cyber-criminality relating to said transaction date. This is advantageous since timing information is readily available and may be correlated to a number of factors. Preferably data regarding the transaction date is used in combination with the location of the sender, more preferably in combination with an external indicator of cyber-criminality relating to said transaction date and/or said location, since this may enable identifying “crime waves” or to identify a “batch” of fraudulent actions performed by the same fraudster or group of fraudsters. Related, preferably data regarding the transaction date is used in combination with an external indicator of cyber-criminality relating to said transaction date to identify crime waves of cyber-criminality, which is in many cases characterized rather by a certain timeframe than by location.

According to another embodiment, said one or more current transaction entities identified in step (b) comprises at least a location of said sender, wherein said location of said sender is preferably obtained and/or verified via GNSS data and/or telecom data and wherein the application of said plurality of signal definitions in step (d) is done for a plurality of features relating to said location of said sender comprising at least any or any combination of the following: a local area crime rate, a local area unemployment rate, an external indicator of cyber-criminality relating to said location. Hereby, GNSS stands for global navigation satellite system and generically refers to a broad class of localization service systems comprising e.g. GPS, Galileo, Glonass and Beidou. Hereby, it is useful to retrieve the location via telecom data if it cannot be retrieved through other means or if there is uncertainty regarding the correctness of the location as indicated by e.g. GPS localization of a mobile device of the sender. As mentioned elsewhere in this document, preferably, location data is used in combination with data regarding the transaction date as this provides superior identification of so-called crime waves.

In another embodiment, for each scoring model, said fraud-indicative data further comprises at least one associated scoring threshold, wherein step (e) comprises comparing, for each scoring model, said associated score and said associated scoring threshold, wherein preferably said score being larger than said scoring threshold is indicative of fraud. This is advantageous since the threshold provides a reference in assessing whether a given score is excessively large or not. In particular, the use of several concurrent scoring models may give rise to confusion regarding whether a single score from one of the models should be perceived as large or not. Therefore, it may be advantageous to let any score be accompanied by an associated threshold. This allows to see whether the scoring model labels the transaction as fraudulent or not (if the threshold is exceeded), and furthermore allows to see to what extent the threshold is exceeded. In general, if more than one scoring model is used, this allows for better comparison across different associated scores and/or normalization with respect to each associated threshold, e.g. by rescaling each score to a range between 0 and 1 with some pre-determined threshold in-between.

According to an embodiment, said signal vector obtained in step (d) preferably consists of a plurality of Boolean signal values, wherein said at least one scoring model comprises a weight-based scoring model, and wherein said step (e) comprises the following sub-steps:
(e.1) for each signal value belonging to said signal vector, determining an associated weight by means of said weight-based scoring model;
(e.2) determining a sum of weights based on a sum of terms, each of said terms obtained as a product of said signal value and said associated weight;
(e.3) determining said score based at least partly on said sum of weights;
   wherein said weight-based scoring model preferably concerns a statistical model taking into account at least one correlation between two different signal values belonging to said signal vector. This is advantageous because it yields a transparent framework for score calculation, particularly in the preferred embodiment wherein said signal vector consists of a plurality of Boolean signal values.

In a further embodiment, said at least one scoring model comprises a gradient boosting machine model and/or a random forest model and/or a support vector machine model. This is advantageous since each of the mentioned model types is suitable for the specific aim of detection of fraudulent transactions.

In another embodiment, for each scoring model, said fraud-indicative data further comprises at least one associated scoring threshold; wherein step (e) comprises comparing, for each scoring model, said associated score and said associated scoring threshold; wherein said system further comprises a screen for display to a user; wherein said current transaction concerns a plurality of current transactions; and wherein said method comprises further step (f) following said step (e):
(a) for each scoring model, determining and displaying on said screen a ranking of said plurality of current transactions ordered according to said score; wherein for each transaction a system-assigned label is determined and displayed, said system-assigned label indicating whether the transaction is deemed fraudulent and/or whether the transaction requires manual inspection by said user; said determining of said system-assigned label based at least partly on said score being larger than said scoring threshold.

This is advantageous since it facilitates automation. Particularly, it allows an efficient and convenient allocation of tasks, whereby straightforward tasks are handled by the system, while more delicate tasks and decisions are kept within the control of a user. Overall, this reduces the burden on the user in the task of supervising transactions and detecting fraudulent transactions.

In yet another embodiment, said system further comprises a user input interface for receiving input from said user; and wherein said method comprises further step (g) following said step (f):
(b) for at least one current transaction belonging to said plurality of current transactions, receiving a user-assigned label indicating whether the user deems said at least one current transaction fraudulent, wherein said user-assigned label differs from the system-assigned label of at least one scoring model determined in step (f).

This is advantageous since it facilitates further automation and enhances interaction between the user and the system. This allows for an even more efficient and convenient allocation of tasks, whereby delicate tasks and decisions are within the control of a user, further reducing the burden on the user in the task of supervising transactions and detecting fraudulent transactions.

In an embodiment, at least one of said at least one model concerns a supervised learning model comprising training data, wherein step (g) further comprises adding said at least one current transaction for which said user-assigned label differs from the system-assigned label to said training data. This has the advantage that the user may actually contribute to the modification of the scoring model, yielding a more accurate scoring model and overall system. This, in its turn, may further reduce the burden on the user in his/her task of detecting fraudulent transactions.

In yet another embodiment, said at least one computer-readable medium comprises a remote computer-readable medium not belonging to said server, wherein the server comprises a network interface for accessing said remote computer-readable medium. This corresponds e.g. to a situation where the server accesses one or more remote data services to receive portions of said historical data.

A further advantage relating to some embodiments of the present invention, lies in the high accuracy provided in identifying relevant records, along with its increased usability and manageability from the perspective of the user operating the system. For instance, the use of data of the current transaction along with historical data regarding relevant related transacting entities desirably has been found to provide better predictive performance than merely using summarized or averaged data. Hereby, in some embodiments, the considerable complexity brought about by working with historical data and by the application of at least one scoring model is kept manageable by adequate organization. Particularly, in some embodiments, historical data is handled in step (c) and (d) and thereby precedes the application of the at least one scoring model in step (d). Hereby, in some embodiments, each of the at least one scoring model applied in step (e) is applied to the same signal vector obtained in step (d). The fact that a common signal vector is used is helpful to the user since it provides a solid basis for a fair comparison between different scoring models. The scoring models, in themselves, are preferably applied generically and interchangeably, without impacting the way in which the historical data is processed. What is further helpful to the user is that preferably at least part of the signal vector and preferably the entire signal vector concerns Boolean signal values, making the input of the at least one scoring model more predictable, and making it feasible for a user to gain familiarity with the typical behavior of several scoring models and comparing them “on an equal footing”. Related, the scoring models may preferably also be on an equal footing in the sense that each of the at least one scoring model may produce at least one associated score, preferably a single score, further facilitating said comparison.

In a further aspect, which is not intended to limit the scope of the invention, according to some preferred embodiments, the present invention relates to a system for identification of fraudulent transactions by a user, wherein the system comprises a means for alerting said user when the system determines a system-assigned label indicating that the transaction requires manual inspection by said user, said means for alerting comprising any or any of the following: a sound alarm, a visual alarm, haptic feedback, a push notification to a mobile device of said user. This is advantageous since it allows a convenient allocation of tasks, whereby straightforward tasks are handled by the system, while more delicate tasks and decisions are kept within the control of a user. Overall, this reduces the burden on the user in the task of supervising transactions and detecting fraudulent transactions.

In a further aspect, the present invention provides a ranking produced by the system according to the present invention, said ranking preferably comprising a visualization either on said screen or on a print-out of said visualization; said ranking preferably comprising for each scoring model a list of a plurality of current transactions, each of said current transactions preferably visualized with an associated score determined by said system. The advantages hereof are similar to those offered by the method or the system.

According to a further aspect, which is not intended to limit the scope of the invention in any way, the invention relates to following points 1-15.

1. A computing system for identification of fraudulent transactions, said computing system comprising
a server, the server comprising a processor, tangible non-volatile memory, program code present on said memory for instructing said processor, optionally a network interface;
at least one computer-readable medium, the at least one computer-readable medium comprising a database, said database comprising
   historical data of at least one transacting entity, said historical data comprising a value of at least one feature relating to said at least one transacting entity;
   a plurality of signal definitions, each signal definition defining a signal output as function of one or more features relating to said at least one transacting entity;
      said computing system configured for carrying out a method for generating fraud-indicative data, said fraud-indicative data comprising a score, said method comprising the steps of:
(a) providing data of a current transaction to said server;
(b) identifying one or more current transacting entities relating to said current transaction by said server based on said data of said current transaction;
(c) obtaining historical data of said one or more current transacting entities together with said plurality of signal definitions from said database;
(d) applying one or more of said plurality of signal definitions to said current transaction and said historical data relating to said one or more current transacting entities, obtaining a signal vector comprising a plurality of signal values;
(e) applying at least one scoring model to said signal vector for generating said fraud-indicative data;
   wherein said fraud-indicative data comprises at least one associated score for each scoring model; wherein said signal vector obtained in step (d) comprises a plurality of Boolean signal values; and wherein each of said at least one scoring model applied in step (e) is applied to the same signal vector obtained in step (d).

2. The computing system according to point 1, wherein said signal vector obtained in step (d) consists of a plurality of Boolean signal values.

3. The computing system according to points 1-2, wherein said at least one scoring model comprises at least a first scoring model and a second scoring model different from said first scoring model; and wherein said first and said second model applied in step (e) are applied independently to the same signal vector obtained in step (d).

4. The computing system according to points 1-3, wherein said one or more current transaction entities identified in step (b) comprise at least any or any combination of the following: a device used to execute said current transaction, a sender, a beneficiary, a transaction date, a transaction channel, a location of said sender.

5. The computing system according to points 1-4, wherein said one or more current transaction entities identified in step (b) comprises at least a sender, and wherein the application of said plurality of signal definitions in step (d) is done for a plurality of features relating to said sender, said plurality of features comprising at least any or any combination of the following: age, gender, income level, civil status, transaction pattern over time, geographic transaction pattern, first use of IP address, first use beneficiary account, first use of said device used to execute said current transaction or of app running on said device, first use of fingerprint within a payment app, previous transfer between own accounts, first transaction after enrolment, cardless cash after enrolment, cardless cash after limit increase, first use of cardless cash, transaction after request login ID, first use of easy PIN reset, first use language of client, limited use of internet service provider.

6. The computing system according to points 1-5, wherein said one or more current transaction entities identified in step (b) comprises at least a transaction date, and wherein the application of said plurality of signal definitions in step (d) is done for a plurality of features relating to said transaction date comprising at least any or any combination of the following: a time of the day and weekday, a seasonal feature for distinguishing e.g. Christmas or summer holidays, a current weather, simultaneousness of a fraud-relevant event such as a version release date of Kali Linux, an external indicator of cyber-criminality relating to said transaction date.

7. The computing system according to points 1-6, wherein said one or more current transaction entities identified in step (b) comprises at least a location of said sender, wherein said location of said sender is preferably obtained and/or verified via GNSS data and/or telecom data and wherein the application of said plurality of signal definitions in step (d) is done for a plurality of features relating to said location of said sender comprising at least any or any combination of the following: a local area crime rate, a local area unemployment rate, an external indicator of cyber-criminality relating to said location.

8. The computing system according to points 1-7, wherein for each scoring model said fraud-indicative data further comprises at least one associated scoring threshold, and wherein step (e) comprises comparing, for each scoring model, said associated score and said associated scoring threshold, wherein preferably said score being larger than said scoring threshold is indicative of fraud.

9. The computing system according to points 1-8, wherein said signal vector preferably consists of a plurality of Boolean signal values, wherein said at least one scoring model comprises a weight-based scoring model, and wherein said step (e) comprises the following sub-steps:
(e.1) for each signal value belonging to said signal vector, determining an associated weight by means of said weight-based scoring model;
(e.2) determining a sum of weights based on a sum of terms, each of said terms obtained as a product of said signal value and said associated weight;
(e.3) determining said score based at least partly on said sum of weights;
   wherein said weight-based scoring model preferably concerns a statistical model taking into account at least one correlation between two different signal values belonging to said signal vector.

10. The computing system according to points 1-9, wherein said at least one scoring model comprises a gradient boosting machine model and/or a random forest model and/or a support vector machine model.

11. The computing system according to points 8-10, wherein for each scoring model said fraud-indicative data further comprises at least one associated scoring threshold; wherein step (e) comprises comparing, for each scoring model, said associated score and said associated scoring threshold; wherein said system further comprises a screen for display to a user; wherein said current transaction concerns a plurality of current transactions; and wherein said method comprises further step (f) following said step (e):
(f) for each scoring model, determining and displaying on said screen a ranking of said plurality of current transactions ordered according to said score; wherein for each transaction a system-assigned label is determined and displayed, said system-assigned label indicating whether the transaction is deemed fraudulent and/or whether the transaction requires manual inspection by said user; said determining of said system-assigned label based at least partly on said score being larger than said scoring threshold.

12. The computing system according to point 11, wherein said system further comprises a user input interface for receiving input from said user; and wherein said method comprises further step (g) following said step (f):
(g) for at least one current transaction belonging to said plurality of current transactions, receiving a user-assigned label indicating whether the user deems said at least one current transaction fraudulent, wherein said user-assigned label differs from the system-assigned label of at least one scoring model determined in step (f).

13. The computing system according to point 12, wherein at least one of said at least one model concerns a supervised learning model comprising training data, and wherein step (g) further comprises adding said at least one current transaction for which said user-assigned label differs from the system-assigned label to said training data.

14. Use of a system according to points 11-13 for identification of fraudulent transactions by a user, wherein the system comprises a means for alerting said user when the system determines a system-assigned label indicating that the transaction requires manual inspection by said user, said means for alerting comprising any or any of the following: a sound alarm, a visual alarm, haptic feedback, a push notification to a mobile device of said user.

15. A ranking produced by the system according to points 11-13, said ranking comprising a visualization either on said screen or on a print-out of said visualization; said ranking comprising for each scoring model a list of a plurality of current transactions, each of said current transactions visualized with an associated score determined by said system.

The invention is further described by the following non-limiting examples which further illustrate the invention, and are not intended to, nor should they be interpreted to, limit the scope of the invention.

The present invention will be now described in more details, referring to examples that are not limitative.

### EXAMPLES

### Example 1

### Example Workflow

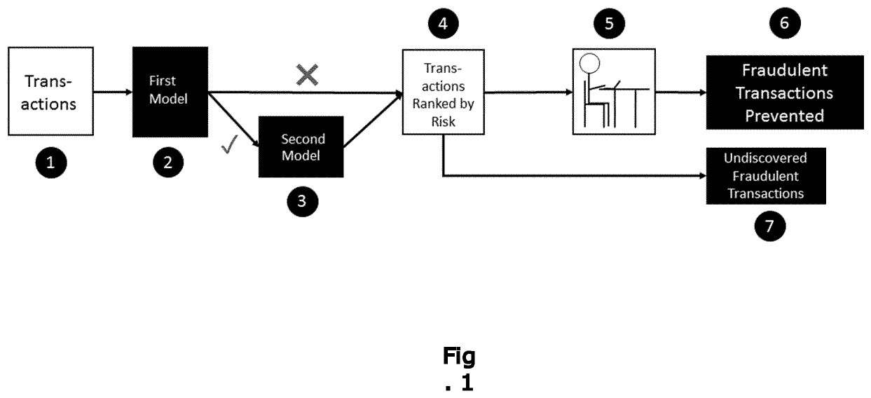

FIG. 1 illustrates an example workflow relating to the present invention, with reference signs (1)-(7) referred to accordingly below. Data on current transactions (1) is fed to the system. The system comprises a first model module (2) which processes the current transactions according to a first, signal-based alert model, i.e. a cyber risk scoring model and ranks all transactions. Hereby, the signal vector concerns a vector of Boolean signal values, and the cyber risk scoring model is weight-based and statistical, taking into account correlations between different signal values. The system further comprises a second model module (3) which reprioritizes the list of alerted transactions. Hereby, note that the second model module (3) may use the output of the first model module (2) and thus work together with the first model in a dependent fashion, but may as well work independently from the first model module (2), whereby the same signal vector used by the first model module (1) is taken as input by the second model module (2).

Hereby, the second model concerns a machine learning model, e.g. gradient boosting machine, random forest or support vector machine. A specific example is a random forest algorithm in which 100 or 1000 fairly deep decision trees are used to classify a transaction as low risk or high risk transaction. The second model can reprioritize the list of transactions and put the true frauds higher up in the list, thus increasing the efficiency of the manual work made by the domain experts, and optimally allowing them to identify truly fraudulent transactions that they otherwise would have missed due to time restrictions. Hereby, the second model uses the same signal vector as the first model, defining combinations of signals that are too complex to identify by human. The second model calculates a new risk score, which determines the new rank of the transaction. The model learns from historical events (list of triggered signals and whether the transaction was identified as a true fraud or not).

The output of the second module model (3) is a list of transactions ranked by risk (4). The transactions with highest rank are manually investigated by the domain expert (5). Actions are taken to prevent the discovered fraud (6). The number of fraudulent events which are undiscovered (7), due to low rank, has been decreased by running the second model on top of the first model.

### Example 2

### Prior Art Method and System for Fraud Detection of Motor Vehicle Accidents

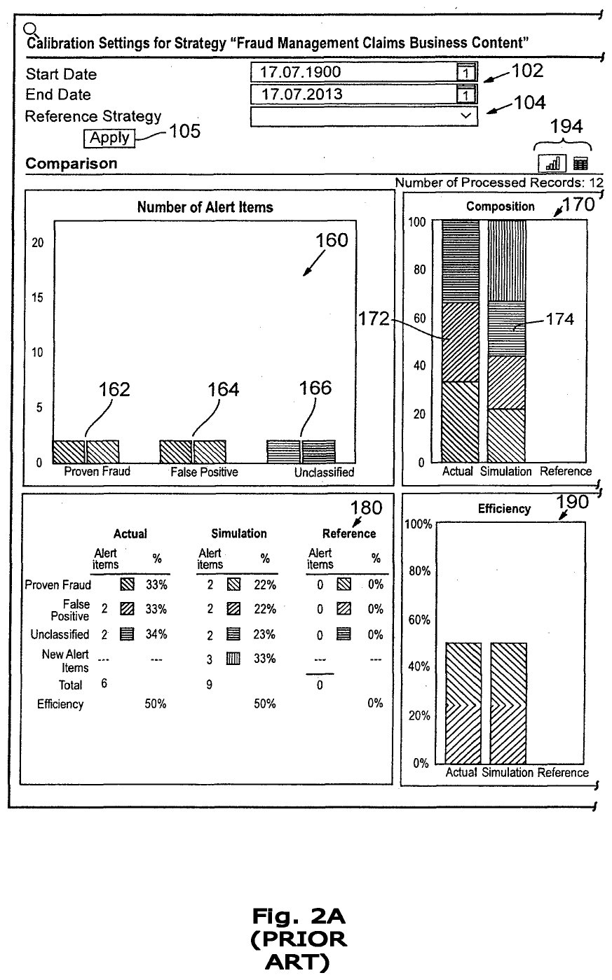

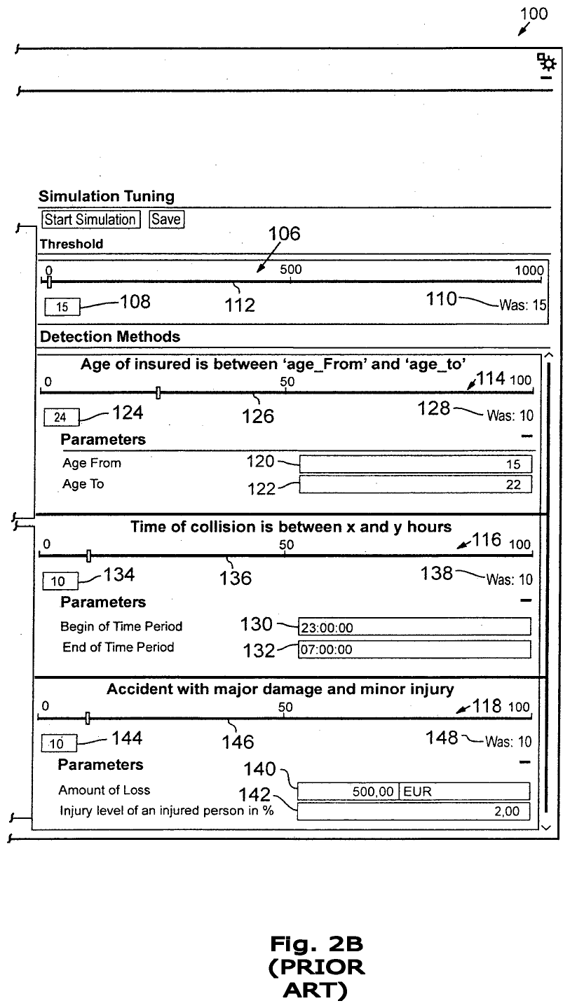

FIGS. 2A and 2B together provide an illustration of a prior art user interface according to EP 2 866 168. Particularly, an exemplary user interface 100 is displayed for calibrating a fraud detection system, such as to detect fraud through a review of electronic records. The user interface 100 is designed to permit a business user without technical database skills to define a search strategy, to conduct a simulated search (or simulation) using the search strategy on a set of known records, to display the results of the search to the user in a graphical format and, based on the results of the simulation, to calibrate (i.e., to revise as necessary or accept) the strategy to achieve a desired number of hits. In some implementations, the strategy is referred to as a “trial” strategy when run initially on known records and then becomes known as a “current” strategy or “version” once calibrated to achieve a desired number of results and configured to run on current records.

A date field 102 allows the user to specify a “start date” and an “end date” for the search strategy to filter results according to a date associated with each record. In the illustrated implementation, the start date is Jul. 17, 1900 and the end date is Jul. 17, 2013. A field 104 allows the user to specify a reference strategy. A reference strategy is another search strategy, such as one that has already been completed based on separate inputs, and can be used for various purposes, such as to compare the performance of a current search strategy with a past search strategy. There is an Apply button 105 that functions to execute the currently specified search strategy on the indicated dates (and any optional reference strategy that is specified) as well as on the other specified inputs indicated.

At the right side of the user interface 100, there is a field 106 entitled “Threshold” for the user to specify a threshold. As indicated in a box 108, the current threshold is set at 15, and was previously also set at 15 as indicated at field 110. A slider 112 can also indicate the threshold and provide a visual cue to the user of the current threshold and the effects of modifying it. That is, the relative position of the slider 112 between the 0 and 1000 limits is approximately correlated with the numerical value (“15”) shown in the “box” 108.

Below the threshold field 106, there can be one or more fields, such as the fields 114, 116 and 118 as shown, to allow the user to modify different inputs, e.g., criteria associated with the detection strategy. These inputs or criteria are also referred to as “detection methods.”

The field 114 relates to an age. In this example, the fraud detection system and methods concern fraud in insurance claims relating to motor vehicle accidents. The age of the insured criterion is currently set for age 15 to age 22 as indicated in the fields 120 and 122, respectively, for these parameters. As indicated at box 124 and on slider 126, the weighting factor for the age 15 to age 22 parameter has been set to 24. Previously, as indicated at 128, the weighting factor for this parameter was set to 10.

The field 116 is a time of collision input or criterion. In this example, the time of collision criterion has been set for 23:00 (11:00 pm) to 07:00 (7:00 am), e.g., to focus on records of accidents occurring during nighttime conditions, as indicated at fields 130 and 132, respectively. As indicated at box 134 and on slider 136, the weighting factor for records that meet the 23:00 to 07:00 time of collision parameters is currently set to 10. Previously, as indicated at 138, the weighting factor for this parameter was also set to 10.

The field 118 is an input or criterion for accidents involving major damage and minor injury. In this example, an amount of loss parameter has been set for 500.00 euros, and an injury level parameter has been set at 2%, as indicated at fields, 140, 142, respectively. As indicated at box 144 and on slider 146, the weighting factor for this parameter is currently set to 10. Previously, as indicated at 148, the weighting factor for this parameter was also set to 10.

In this example, an alert is triggered when weighting factor times the corresponding criteria or rule result, when summed for all criteria or rules, exceeds the threshold.

Above the threshold field 106, there are Simulation Tuning controls. A first control is a Start Simulation button 150 and a second control is a Save button 152. The Start Simulation button 150 is actuatable to execute the selected detection strategy as specified in the fields 102, 106, 114, 116 and 118 on historical and new records. The Save button 152 is actuatable to save the current results.

A graph 160 provides a visual indication of the number of hits, and relates to a Proven Fraud category 162, a False Positive category 164 and an Unclassified (or Undetermined) category 166. To the right of the graph 160, a bar chart 170 is provided relating to a first bar 172 and a second bar 174. Below the graph 160, a chart 180 is provided relating to a numerical breakdown of the composition and an efficiency calculation. A bar chart 190 provides a graphical representation of the efficiency calculations from the chart 180. A set of icons 194 indicates that the interface 100 is presently in a first mode in which graphs are displayed and can be toggled between this mode and a second mode in which data are shown in a list format.

### Example 3

### Example Method and System

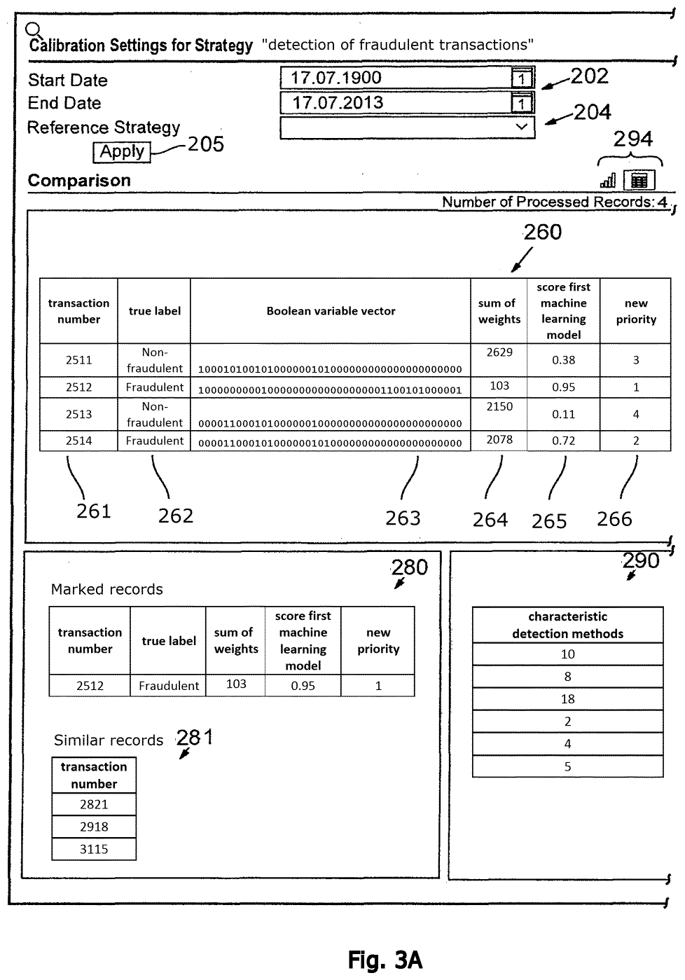

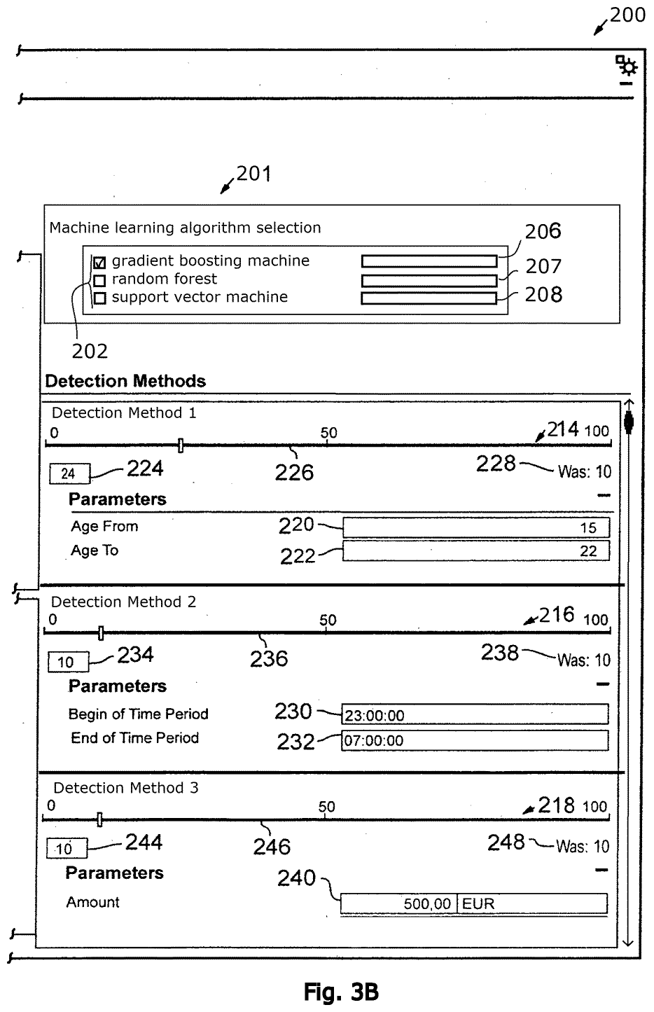

FIGS. 3A and 3B together provide an exemplary user interface 200 according to the present invention. Aspects of this user interface that are particularly non-obvious, hereafter referred to as “distinguishing aspects”, are shown together with more generic elements of the user interface, which are to some extent chosen in analogy with the prior art user interface of FIGS. 2A and 2B. Hereby, any similarity with the prior art user interface should not be interpreted as limiting the invention in any way. Rather, the more generic elements merely serve to illustrate the invention by means of a working embodiment, and are displayed analogously to the prior art interface 100 mainly to ease the understanding of the invention, and to show how the combination of a prior art user interface with the distinguishing aspects of the present invention leads to several advantageous effects that are not obtainable for a user of the prior art interface 100.

Said distinguishing aspects primarily relate to the joint list 260, the marked records list 280, the similar records list 281, the characteristic detection methods list 290, and the machine learning algorithm selection panel 201. Said distinguishing aspects further relate to the way in which the position of sliders 226, 236, 246, i.e. the several weighting factors of the detection methods, are taken into account explicitly for the calculation of the sum of weights 264, but not for the calculation of the machine learning model score(s) 265. All these aspects are discussed in detail below, in conjunction with a description of the functioning of the user interface 200 as a whole.

In this example, the exemplary user interface 200 is intended for assisting the user in the calibrating of strategies for the detection of fraudulent transactions. Importantly, the calibration does not relate to a single detection strategy, as in the prior art user interface 100, but to at least two distinct detection strategies. A first advantage hereof is that it allows a user familiar with a traditional first detection strategy to calibrate a second detection strategy based on a machine learning algorithm, with potentially superior performance. A second advantage is that it allows the user to calibrate two strategies at the same time, having the advantage of “a second opinion” during the detection of fraudulent transactions. A third advantage is that the user may aim for calibrating the traditional first detection algorithm, which is more easy to understand and manage, by letting a machine learning algorithm provide hints toward improvements of the traditional first detection algorithm.

The first detection strategy is based on a set of detection methods, in this example 42 in number, each of them provided with parameter fields 220, 222, 230, 232, 240 and a slider 226, 236, 246 for setting weighting factors, similar to that of the prior art user interface 100. Also the calculation of the first detection score 264, also referred to as the “sum of weights score” or “sum of weights”, is similar to the prior art user interface 100, whereby the first detection score 264 is a sum of terms, each term being the product of the detection method output multiplied by the weighting factor. In this example, all the detection method outputs are Boolean, i.e. they are transformed to either 0 or 1, preferably corresponding to “true” or “false” with respect to the detection method description, which may or may not be formulated as a true/false-statement. This leads to a Boolean variable vector 263 displayed in the joint list 260, indicating a Boolean variable value for each of the detection methods, in this example being 42 in number. Hereby, of these 42 detection methods only three are displayed on FIG. 3B, but the others can be displayed by the user by scrolling down. Naturally, a smaller or larger number of detection methods is possible, e.g. 2, 3, 5, less than 10, 10, 20, 30, 40, 50, 60, 70, more than 70, 80, more than 80. Different from the prior art user interface, with threshold field 106, the first detection strategy does not involve a threshold to which the output of the first detection strategy is compared, but rather uses the score 264 for a variety of purposes such as display to the user via the joint list 260, comparison with the score(s) of the second detection strategy, processing for identification of marked records and/or similar records and/or characteristic detection methods, etc. In an alternative embodiment of the invention, however, a threshold similar to that of the prior art user interface could be introduced for any or any combination of the first and second detection strategy without problem, as such a provision is compatible with and complementary to the invention.

The second detection strategy is based on at least one machine learning algorithm, having as input another set of detection methods, which is advantageously chosen equal to the detection methods of the first detection method, in this example 42. Furthermore, the advantageous choice is made to use the Boolean variable vector as single input to the machine learning algorithm, i.e. without using the weighting factors. Each of these measures has the benefit of decreasing both the necessary mental and physical effort of the user with respect to the machine learning algorithm. Particularly, given the inherent potential of the machine learning methods, combined with the large number of detection methods, 42 in this example, the number of possible values the Boolean variable vector can take on amounts to 2⁴², which is larger than 10¹², clearly demonstrating the distinctive character of the input provided to the machine learning algorithm(s). Moreover, as the machine learning algorithms may associate large or small scores with any combination of Boolean variable values, without being bound by the constraint of linear combinations according to a strategy based on the sum of linearly weighted detection methods, the machine learning algorithms have a much finer sense of distinguishing between fraudulent and non-fraudulent transactions.

This larger sense of distinguishing may be understood as follows. For instance, the change of a single Boolean variable value in view of its combination with two or three correlated other variable values may indicate a big difference in practice and may be adequately be reflected in the machine learning model behavior, but can never be modeled by a linear sum of linearly weighted detected methods, since such a sum cannot model the correlation between different variable values. Hence, by choosing detection methods for the machine learning algorithm(s) equal to the detection methods of the first detection method, and by using the Boolean variable vector as single input to the machine learning algorithm(s) and not using the weighting factors, the complexity of both the problem and the user interface is greatly simplified for the user, without losing the advantage of the machine learning algorithms, being able to capture correlation between different outputs of the detection methods. This said, machine learning algorithms still confront the user with great complexity, and therefore, the configuration and, if applicable, the training of these algorithms is preferably left over to an expert which is typically different from the user. Therefore, the invention advantageously confronts the user with the machine learning algorithms in their “operational state”. Rather than looking for the most suitable or best-configured machine learning algorithm, the user may direct its attention to the more practical question of which machine learning algorithm, optionally configured with some algorithm parameter, happens to perform best for the task at hand. Whether the algorithm owes its superior performance more to good configuration or is simply better suited for the job, is a question that need not necessarily be addressed by the user, and may or may not be irrelevant for the tasks performed by the user.

The user interface 200 comprises a machine learning algorithm selection panel 201. This allows the user to select the one or more machine learning algorithms that may be used by the second detection strategy for calculating scores. The selection may be done by corresponding check-boxes 202. In case more than one machine algorithm is selected, preferably one score per algorithm and per record is output and preferably displayed at least in the joint list 260, e.g., by means of a separate additional column per algorithm. In another embodiment, the detection strategy may take the arithmetic, geometric or weighted average of individual scores produced by the different machine learning algorithms and add these up to a single “second-detection-strategy score”, which may preferably be displayed in the joint list 260. In a preferred embodiment, the machine learning algorithms from which the user may choose one or more are gradient boosting machine, or, equivalently, gradient boosting model, random forest (model), and support vector machine (model). Preferably, each of these algorithms is configured beforehand by an expert to the level required by the algorithm. In some cases, and subject to the insights of the expert, the algorithm may allow one or more input parameter to be set by the user. On the one hand, this may relate to a choice between different “flavors” of the algorithms, i.e. different variants of the algorithms at hand. In such case, the parameter is preferably chosen by means of a drop-down menu. On the other hand, this may relate to specific parameter values within the algorithm, such as the tree-level-parameter which may take on positive integer values and relates to a stopping condition in the random forest. For support vector machine, this one or more parameter may e.g. relate to the training set involved in the training involved due to the supervised nature of the support vector machine model. For gradient boosting, this may relate to choosing for regular vs. stochastic gradient boosting. Such parameters may be set via the respective algorithm parameter fields 206, 207, 208.

The joint list 260 provides a list of records which are processed, in this example 4, with transaction numbers 2511-2514 as indicated in the transaction number column 261. The records are hereby processed according to both the first and the second detection strategy. The joint list comprises a column 262 for the true label, which may be available only for existing records and may be unavailable for new records. The joint list 260 further comprises a column 263 for the Boolean variable vector, corresponding to the output values of each of the detection methods, in this case 42. Another column 264 indicates the sum of weights, presented alongside with one or more columns 265 for each of the scores of the first machine learning algorithm and optional further algorithms, or, in an alternative embodiment, the column for the single score calculated for the entire second detection strategy. The column 266 indicates the new priority that may be derived based on the results of the second detection strategy. The joint list may be ordered according to transaction number (as displayed) but may be ordered according to any column, e.g., in descending order based on sum of weights or based on score of the first machine learning model.

The marked records list 280 provides an additional detection and calibrating tool for the user, automatically displaying the at least one record for which results of the first detection algorithm and the second algorithm differ to some predefined extent. The marked records list 280 may be configured to show all records for which any difference is detected (not shown) or it may only show those records for which the difference is very outspoken (as shown), where the latter may be defined in relative terms, showing only “the n records (with n set beforehand) with most outspoken difference” or in absolute terms, by means of some threshold applied to the difference. This facilitates the user in characterizing discrepancies between the first and second detection strategy, and may hence be helpful in calibrating the first and/or second detection strategy.

The similar records list 281 provides yet another additional detection and calibrating tool for the user. This may relate to records that are similar to the marked records based on similar results (of e.g. the first and/or second detection strategy) but may also relate to similarities of the Boolean variable vector, which may lead to additional insight.

The characteristic detection methods list 290 provides a further detection and calibrating tool for the user. This may relate to detection methods that are identified by the system as being indicative for records that meet a predefined criterion. For instance, the predefined criterion may relate to seeking out those detection methods whose individual output and/or combined output may be a good predictor for the record being fraudulent or not. This may allow for improved insight and may allow the user to simplify the detection by keeping only the most relevant detection methods and removing others and/or setting the weights for these detection methods higher and/or setting the weights lower for other detection methods for calibrating the first detection strategy. In another embodiment, the characteristic detection method list 290 may relate to seeking out those detection methods whose individual output and/or combined output may lead to discrepancies between the first and the second detection strategy. This may allow for improved insight into the complementary of the detection strategies, e.g. revealing to the user for which type of fraud the second detection strategy may outperform the first detection strategy.

As such, the user interface 200, like the prior art interface 100, is designed to permit a business user without technical database skills to define a search strategy, to conduct a simulated search (or simulation) using the search strategy on a set of known records, to display the results of the search to the user in a graphical format and, based on the results of the simulation, to calibrate (i.e., to revise as necessary or accept) the strategy to achieve a desired number of hits. However, the user interface 200 supports to include the results of a second detection strategy based on machine learning, thereby allowing to calibrate the first detection strategy more effectively and/or to calibrate the second detection strategy either separately or in combination with the first detection strategy. In some embodiments, the aim of the user interface is to support the user in a “trial” approach when run initially on known records and then becomes known as a “current” approach once calibrated to achieve a desired number of results, with either a desired balance between the first and second detection strategy, or a choice between either the first or the second detection strategy. A specific approach can be identified with a unique identifier, and may be referred to as a version.

Similar to the prior art interface 100, the date field 202 allows the user to specify a “start date” and an “end date” to filter results according to a date associated with each record. In the illustrated implementation, the start date is Jul. 17, 1900 and the end date is Jul. 17, 2013. A field 204 allows the user to specify a reference strategy, which may relate to some version of a first or second detection strategy or a combination thereof. A reference strategy is another search strategy, such as one that has already been completed based on separate inputs, and can be used for various purposes, such as to compare the performance of a current search strategy with a past search strategy. There is an Apply button 205 that functions to execute the currently specified search strategy on the indicated dates (and any optional reference strategy that is specified) as well as on the other specified inputs indicated. Examples of possible inputs are explained below in more detail.

Each detection method can be set with generic fields such as the fields 214, 216 and 218 as shown.

The field 214 relates to a first detection method, relating to an age of a person. The age is currently set for age 15 to age 22 as indicated in the fields 220 and 222, respectively, for these parameters. As indicated at box 224 and on slider 226, the weighting factor for the age 15 to age 22 parameter, which only impacts the first but not the second detection strategy, has been set to 24. Previously, as indicated at 228, the weighting factor for this parameter was set to 10.

The field 216 relates to a second detection method, relating to a time period. In this example, the period has been set for 23:00 (11:00 pm) to 07:00 (7:00 am), e.g., to focus on events during nighttime conditions, as indicated at fields 230 and 232, respectively. As indicated at box 234 and on slider 236, the weighting factor for records that meet the 23:00 to 07:00 period parameters is currently set to 10. Previously, as indicated at 238, the weighting factor for this parameter was also set to 10.

The field 218 relates to a third detection method, relating to an amount of the transaction. In this example, the specific amount has been set for 500.00 euros, as indicated at field 240. This amount may relate to a bank limit. As indicated at box 244 and on slider 246, the weighting factor for this parameter is currently set to 10. Previously, as indicated at 248, the weighting factor for this parameter was also set to 10.

A set of icons 294 indicates that the interface 200 is presently in a first mode in which data are displayed in a list format and can be toggled between this mode and another mode in which graphs are shown.

1. Computer-implemented method of identifying potentially fraudulent relevant records in a database comprising:
providing a graphical user interface to a user to display multiple inputs, to receive inputs from the user and to display results,
defining a first detection strategy targeted to detect existing records from the database, the first detection strategy comprising multiple first inputs, wherein the first inputs comprise at least one threshold, at least one detection method, at least one weighting factor, and at least one parameter, wherein the first inputs are individually displayed on said graphical user interface for each of the at least one detection method, wherein the first inputs are individually set for each of the at least one detection method;
defining a second detection strategy targeted to detect said existing records from the database, the second detection strategy comprising multiple second inputs;
executing the first detection strategy and the second detection strategy on existing records and displaying results for review by a user;
dynamically calibrating the first and/or second detection strategy based on the first and second inputs received from the user and displaying any modified results, wherein the calibrated first and/or second detection strategy produces results that were not previously known, due to changes in the first and/or second inputs;
setting the calibrated first and/or second detection strategy; and
executing the calibrated first and/or second detection strategy on new records to detect relevant records warranting investigation,
characterized in that the second detection strategy is different from the first detection strategy;
in that the multiple second inputs of the second detection strategy further comprise an algorithm selection received from the user, said algorithm selection relating to at least one machine learning algorithm for executing said second detection strategy, wherein the at least one detection method of the first detection strategy and the at least one parameter of the first detection strategy are also the at least one detection method of the second detection strategy and the at least one parameter of the second detection strategy comprised in the multiple second inputs of the second detection strategy;
in that said results produced by said calibrated second detection algorithm comprise results for each of the at least one machine learning algorithm selected according to said algorithm selection;
in that said dynamic calibrating of the first and/or second detection strategy further relates to altering said algorithm selection an/or adding a new detection method and/or removing one of said at least one detection method; and
in that said results produced by the first detection strategy and said results produced by the second detection strategy are displayed jointly on said graphical user interface.

2. The method according to claim 1, characterized in that said algorithm selection relates to at least two machine learning algorithms.

3. The method according to claim 1, characterized in that said second detection strategy comprises determining a second score being an output of one of said at least one machine learning algorithm chosen according to the algorithm preference received from the user, wherein said second score is based directly on the multiple second inputs consisting of the algorithm preference, an output of the at least one detection method of the first detection strategy and the at least one parameter of the first detection strategy, and not on a weighting factor.

4. The method according to claim 1, characterized in that said multiple second inputs of the second detection strategy further comprise an algorithm parameter, and in that said dynamic calibrating further relates to altering said algorithm parameter.

5. The method according to claim 1, characterized in that said first detection strategy comprises determining a first score being a linear sum of at least one term, each term being associated with one of said at least one detection method, each term being a product of an output of the detection method and a weighting factor of the detection method wherewith the term is associated.

6. The method according to claim 1, characterized in that said jointly displaying of said results produced by the first detection algorithm and said results produced by the second detection algorithm comprises displaying a first score determined by said first detection strategy and a second score determined by said second detection strategy, wherein
said first detection strategy comprises determining a first score being a linear sum of at least one term, each term being associated with one of said at least one detection method, each term being a product of an output of the detection method and a weighting factor of the detection method wherewith the term is associated; and/or
said second detection strategy comprises determining a second score being an output of one of said at least one machine learning algorithm chosen according to the algorithm preference received from the user, wherein said second score is based directly on the multiple second inputs consisting of the algorithm preference, an output of the at least one detection method of the first detection strategy and the at least one parameter of the first detection strategy, and not on weighting factors.

7. The method according to claim 3, characterized in that for each of said at least one detection method, said output of the at least one detection method is a Boolean variable vector with one Boolean variable per detection method, and in that said second score determined by means of said at least one machine learning algorithm selected according to said algorithm preference is based solely on said Boolean variable without taking into account a weighing factor.

8. The method according to claim 1, characterized in that said records in said database relate to transaction entities and comprise at least any or any combination of the following: a device used to execute a transaction, a sender, a beneficiary, a transaction date, a transaction channel, a location of said sender, wherein said records in said database comprise at least a sender, wherein said at least one detection method relates to any or any combination of the following information relating to said sender: age, gender, income level, civil status, transaction pattern over time, geographic transaction pattern, first use of IP address, first use beneficiary account, first use of said device used to execute said current transaction or of app running on said device, first use of fingerprint within a payment app, previous transfer between own accounts, first transaction after enrolment, cardless cash after enrolment, cardless cash after limit increase, first use of cardless cash, transaction after request login ID, first use of easy PIN reset, first use language of client, or limited use of internet service provider.

9. The method according to claim 8, characterized in that said records comprise at least a transaction date, wherein said at least one detection method relates to any or any combination of the following: a time of the day and weekday, a seasonal feature for distinguishing, a current weather, simultaneousness of a fraud-relevant event, or an external indicator of cyber-criminality relating to said transaction date.

10. The method according to claim 8, characterized in that said records comprise at least a location of said sender, wherein said location of said sender is obtained and/or verified via GNSS data and/or telecom data and wherein the application of a plurality of signal definitions is done for a plurality of features relating to said location of said sender comprising at least any or any combination of the following: a local area crime rate, a local area unemployment rate, an external indicator of cyber-criminality relating to said location.

11. The method according to claim 1, characterized in that said at least one machine learning algorithm comprises a gradient boosting machine model and/or a random forest model and/or a support vector machine model.

12. The method according to claim 1, characterized in that said jointly displaying of said results produced by the first detection strategy and said results produced by the second detection strategy comprises marking at least one record for which results of the first detection algorithm and the second algorithm differ.

13. The method according to claim 12, characterized in that said marking of said at least one record comprises:
calculating a correlation between records for which results of the first detection algorithm and the second algorithm differ, by calculating a correlation between the Boolean variable vectors associated with said records; and
displaying a result relating to said correlation, said result comprising at least one detection method identified as characteristic of said difference between said first and said second detection algorithm.

14. The method according to claim 1, characterized in that said method comprises the further step of:
for at least one record, receiving a user-assigned label indicating whether the user deems said at least one record relevant.

15. The method according to claim 14, characterized in that at least one of said at least one machine learning model concerns a supervised learning model relating to training data, and in that said receiving of said user-assigned label further comprises adding said user-assigned label to said training data.

16. The method according to claim 1, characterized in that said method comprises the further step of:
based on a difference between said results of said first detection strategy and said results of said second detection strategy, alerting the user for advising manual inspection, said alerting comprising any or any of the following: a sound alarm, a visual alarm on said graphical user interface, haptic feedback, a push notification to a mobile device of said user.

17. A computing system for identifying fraudulent relevant records in a database, said computing system comprising
a server, the server comprising a processor, tangible non-volatile memory, program code present on said memory for instructing said processor, optionally a network interface;
at least one computer-readable medium, the at least one computer-readable medium comprising a database, said database comprising existing records;
said computing system configured for carrying out a method for identifying said relevant records in said database, said method comprising the steps of:
providing a graphical user interface to a user to display multiple inputs, to receive inputs from the user and to display results,
defining a first detection strategy targeted to detect existing records from the database, the first detection strategy comprising multiple first inputs, wherein the first inputs comprise at least one threshold, at least one detection method, at least one weighting factor, and at least one parameter, wherein the first inputs are individually displayed on said graphical user interface for each of the at least one detection method, wherein the first inputs are individually set for each of the at least one detection method;
defining a second detection strategy targeted to detect said existing records from the database, the second detection strategy comprising multiple second inputs;
executing the first detection strategy and the second detection strategy on existing records and displaying results for review by a user;
dynamically calibrating the first and/or second detection strategy based on the first and second inputs received from the user and displaying any modified results, wherein the calibrated first and/or second detection strategy produces results that were not previously known, due to changes in the first and/or second inputs;
setting the calibrated first and/or second detection strategy; and
executing the calibrated first and/or second detection strategy on new records to detect relevant records, warranting investigation,
characterized in that the second detection strategy is different from the first detection strategy;
in that the multiple second inputs of the second detection strategy further comprise an algorithm selection received from the user, said algorithm selection relating to at least one machine learning algorithm for executing said second detection strategy, wherein the at least one detection method of the first detection strategy and the at least one parameter of the first detection strategy are also the at least one detection method of the second detection strategy and the at least one parameter of the second detection strategy comprised in the multiple second inputs of the second detection strategy;
in that said results produced by said calibrated second detection algorithm comprise results for each of the at least one machine learning algorithm selected according to said algorithm selection;
in that said dynamic calibrating of the first and/or second detection strategy further relates to altering said algorithm selection an/or adding a new detection method and/or removing one of said at least one detection method; and
in that said results produced by the first detection strategy and said results produced by the second detection strategy are displayed jointly on said graphical user interface.

18. (canceled)

19. A computer program product comprising computer-executable instructions for performing the method according to claim 1.

20. The method according to claim 1, wherein the relevant records are potentially fraudulent records.

21. The computing system according to claim 17, wherein the relevant records are potentially fraudulent records.
